(19) United States
(12) Patent Application Publication
(10) Pub. No.: US 2018/0353874 A1
(43) Pub. Date: Dec. 13, 2018

(54) LIQUID PURIFICATION DEVICE

(71) Applicant: Electrophor Inc., Woodmere, NY (US)

(72) Inventors: Denis Vladislavovich Baigozin, St. Petersburg (RU); Alexei Leonidovich Kuzmin, St. Petersburg (RU); Dmitry Andreevich Surzhenko, St. Petersburg (RU); Joseph L. Shmidt, Woodmere, NY (US)

(21) Appl. No.: 15/777,235

(22) PCT Filed: Jul. 21, 2016
(86) PCT No.: PCT/RU2016/000465

§ 371 Date: May 18, 2018

(30) Foreign Application Priority Data
Dec. 10, 2015 (RU) 2015153119

(51) Int. Cl. B01D 15/22; B01D 15/18; C02F 1/28; C02F 1/42

(52) U.S. Cl. CPC B01D 15/22; B01D 15/18; C02F 2201/002; C02F 1/42; C02F 2301/02; C02F 1/283

(57) ABSTRACT

The invention relates to the liquid purification devices, provided for water purification from local sources, for example, a holes, a wells, etc. and/or a municipal sources for domestic and/or drinking water supply and is intended for use in living conditions and in the country and a garden plots.

The liquid purification device consisting of the body frame that includes the upper and the lower filtering zones with the filter medium inside, the feed liquid flow changing direction means, the air vent means for air from the lower filtering zone removal and having the air outlet element located in the upper wall of the air vent means, characterized in that the device is configured for air removal from the lower filtering zone by an upward feed liquid flow of at the beginning of the filtration process during the filling of the device with feed liquid and the means for changing the direction of feed liquid flow containing the filter medium that is simultaneously the lower filtering zone and located inside the device, is formed by the chamber of variable shape and size with the filter medium and with the inlet holes located in the upper or the upper and the lower parts of the side wall of this chamber and the vertically oriented inner annular space that is in liquid communication with the chamber through the inlet holes located in the upper or the upper and the lower parts of the side wall of this chamber and formed by the inner side wall of the body frame of the liquid purification device and the outer side wall of the chamber and tapers to the lower part of the body frame of the liquid purification device, that contains the filter material, and is designed to pass feed liquid from the upper filtering zone into the chamber through the inlet holes in the radial direction.

### FIELD OF INVENTION

The invention relates to a liquid purification devices, and provided for water purification from local sources, for example, holes, wells, etc. and/or municipal sources for domestic and/or for drinking water supply and is intended for use in living conditions and in the country and garden plots.

### BACKGROUND OF THE INVENTION

The operating principle of the invention relates to a liquid purification devices of pressureless type, because liquid flows through a device by gravity under the gravity force. The known constructions of pressureless type liquid purification devices typically include elements such as a source liquid tank and a purified liquid tank that communicate with each other through a liquid purification device. Devices known from the state of the art operate as follows: source liquid is poured in a source liquid tank from where it flows by gravity into a liquid purification device, where liquid purification process is performed, and then from a liquid purification device purified liquid flows to a purified liquid tank. Devices known from the state of the art generally consist of a body frame and a filtering zone formed by a filter medium that consists of a filter material and a post-filtering element. A granular or a fibrous sorbents, for example, an activated carbon, an ion exchange resin, an ion exchange fiber or a mixture of these sorbents are generally used as filter material in liquid purification devices known from the state of the art. A meshy post-filters or a hollow fiber elements can be used as a post-filtering element in known from the state of the art a liquid purification devices.

The liquid purification device according to U.S. Pat. No. 8,080,160 [Mitsubishi Rayon Co., Ltd, IPC B01D 63/02, B01D 41/02, B01D 61/18, B01D 61/00, published on 20.12.2011] is an example of a device of specified type known from the state of the art. The device of U.S. Pat. No. 8,080,160 consists of a body frame including an upper filtering zone and a lower filtering zone separated by a mesh of liquid permeable material with a filter medium placed in both zones. In an upper filtering zone a filter material is used as a filter medium, and in a lower filtering zone a hollow fiber element (hereinafter, the HF element) is used as a filter medium. The body frame of the liquid purification device consists of a lower main part and a lid. Inlet holes for source liquid are made in the lid of the body frame of the liquid purification device. The lower main part of the body frame is provided with outlet holes for purified liquid.

The device according to U.S. Pat. No. 8,080,160 operates as follows. Source liquid through the holes made in the lid passes down from the top through a filter material of the upper filtering zone and then penetrates into the HF element of the lower filtration zone. Purified liquid exits through holes formed in a bottom wall of the body frame of the liquid purification device.

The main disadvantage of the above described liquid purification device is that during filtration, when liquid flows through the filtering zones, air is released from the filtering zones. Smallest air bubbles agglomerate and expand over time, which leads to blocking at least part of a filter material, which reduces speed and efficiency of liquid purification.

In order to facilitate the collection of air and its removal outside of a purification device, such devices are made with an air vent means. This air vent means is usually made in the form of a vertical tube of small diameter, but sufficient to accumulate the volume of air necessary to overcome the resistance of the liquid. The air outlet is formed in the upper wall of the tube.

Device according to U.S. Pat. No. 4,306,971 [Chemie Brita Gerate Ing., IPC B01D 23/10, published on Dec. 22, 1981] is known from the state of the art. The liquid purification device consists of a body frame containing a filtering zone with a filter medium located inside and an air vent means for removal air from the filtering zone. The air vent means consists of a base, a vertical part and an air outlet element located in the upper wall of the vertical part. An inlet holes for source liquid are made in a base of the air vent means. The air vent means also performs a function of a lid for the body frame of the liquid purification device. The outlet holes for purified liquid are made in a lower part of the body frame of the liquid purification device.

The liquid purification device according to U.S. Pat. No. 4,306,971 operates as follows. The liquid purification device is located between a source liquid tank and a purified liquid tank. The source liquid tank is filled with source liquid, while the height of a liquid column should not exceed the height of a vertical part of the air vent means. Source liquid flows to the filtering zone through the inlet holes for source liquid that are made at the base of the air vent means. Liquid displaces air from the filtering zone while passing through the filter medium. Displaced air rises along the vertical part of the air vent means and is discharged from the device through the air outlet element. At the same time purified liquid flows into the purified liquid tank through the outlet holes for purified liquid.

The liquid purification device according to U.S. Pat. No. 4,306,971 has a number of disadvantages. The main disadvantage of this device is that source liquid enters to the filtering zone from above. Since there is air in the filtering zone, which must rise to the top, liquid and air flows collide, which reduces the filtration rate of liquid and prevents efficient air removal from the liquid purification device.

There is a collision of liquid and air flows because air present in the filtering zone must rise to the top. This effect reduces the filtration rate of liquid and prevents efficient removal of air from the liquid purification device. Also the construction of the air vent means comprises the air outlet only in the central part of the liquid purification device. Air bubbles can form in the areas of a filtering zone, near the side walls of the body frame and near the base of the air vent means, which will lead to an additional decrease in the filtration rate.

The liquid purification device according to EP Patent Application No. 2754642 [Mitsubishi Rayon Co., Ltd, IPC B01D 63/00, B01D 63/02, C02F 1/28, C02F 1/44, published on Jul. 16, 2014] is known from the state of the art. The liquid purification device consists of a body frame inside of which an upper and a lower filtering zones and a tube for feed liquid collecting are located. Therein the upper and the lower filtering zones are separated by an impermeable barrier and contain a filter medium. Also the liquid purification device according to EP 2754642 comprises an air vent means that is intended for air removal from the lower filtering zone and is made in the form of a vertical tube, in the upper wall of which there is an air outlet element. The filter medium of the upper filtering zone is a sorption material. Filter medium of the lower filtering zone is made in the form of HF element. The upper wall of the body frame of the liquid purification device is provided with inlet holes for source liquid. The tube for feed liquid collecting is located in the central part of the upper filtering zone and is connected to the lower filtering zone. The side walls of the tube for feed liquid collecting are permeable for liquid. The air vent means is disposed on an outer upper surface of the liquid purification device body frame above the level of source liquid holes that are located in the upper wall of the body frame of the liquid purification device. The air outlet element is formed as a hole and located in central part of the upper wall of the air vent means. The air vent means is connected to the tube for feed liquid collecting. The outlet hole for purified liquid is formed in the base of the body frame of the liquid purification device.

The liquid purification device operates as follows.

Source liquid enters the upper filtering zone through the inlet holes for source liquid located in the upper wall of the body frame of liquid purification device, and then passes the filter material. After which liquid enters the lower filtering zone through the tube for feed liquid collecting. Purified liquid after passing through the lower filtering zone, exits the liquid purification device through the outlet hole for purified liquid formed in the base of the body frame of the liquid purification device. During liquid passes through the lower filtering zone, air is expelled from it. This air enters the air vent means through the tube for feed liquid collecting and then exits above the liquid purification device through the air outlet element.

The liquid purification device according to the application EP 2754642 has a number of disadvantages. For example, feed liquid enters the lower filtering zone from the top and flows down from the top, while air released from the lower filtering zone rises top from the down. Thus, there is a collision between liquid and air flows inside the lower filtration zone. In addition, there is a collision between liquid and air flows in the tube for feed liquid collecting because liquid flows into the lower filtering zone through the tube for feed liquid collecting and air from the lower filtering zone enters the air vent means also through the tube for feed liquid collecting. These collisions degrade efficiency of air discharging from the lower filtering zone, which leads to the fact that air partly remains in the lower filtering zone. This effect reduces the speed and efficiency of liquid purification. In addition, based on description of the device according to the application EP 2754642, the tube for feed liquid collecting is permeable for liquid, and therefore permeable to air, so there is a possibility of air penetration, which goes up along the tube through its side walls into the volume of the filter material of the upper filtering zone. This fact leads to degradation of liquid passage through the upper filtering zone and to decrease of the liquid filtration efficiency.

Also a disadvantage of referred liquid purification device is that the lower and upper filtering zones are separated by a partition and the liquid from the upper filtering zone enters the lower filtering zone only through the tube for feed liquid collecting located in the central part of the filtering zone. Thus, during the filtration process mainly the central part of the lower filtering zone is used, so the lower filtering zone is not used effectively.

The liquid purification device according to U.S. Pat. No. 6,638,426 [The Clorox Company, IPC B01D 27/02, B01D 27/14, published on Oct. 28, 2003] is known from the state of the art. The liquid purification device consists of a body frame comprising an upper and a lower filtering zones with a filter medium arranged inside, an air vent means for air vent from the lower filtering zone and configured as an inverted feeder. The air vent means consists of a liquid permeable conical base and liquid impermeable vertical part that is provided with an air outlet element located in the upper wall of the air vent means. A sorption filter material is located in the upper filtering zone. HF element is located in the lower filtering zone.

The air vent means is located in the central part of the upper filtering zone. In this case the base of the air vent means simultaneously performs the function of the partition between the lower and upper filtering zones. The holes for liquid flowing from the upper filtering zone to the lower filtering zone are formed in the base of the air vent means. The height of the vertical part of the air vent means exceeds the height of the upper filtering zone so that a portion of the vertical part of the air vent means, including the air outlet element, is located outside the upper filtering zone. The air outlet element is made in the form of a hole.

The body frame of the liquid purification device consists of a lower main part and a lid. The outlet holes for purified liquid are made in the lower main part. The lid of the body frame of the liquid purification device consists of two elements: a lower part containing inlet holes for enter source liquid to the upper filtering zone and a convex upper part in which air holes are made, that are operatively connected with the air outlet element of the air vent means.

The liquid purification device of U.S. Pat. No. 6,638,426 operates as follows.

Source liquid enters the upper filtering zone through the holes located in the lower part of the lid, then passing through the filter material of the upper filtering zone enters the lower filtering zone through the holes formed in the base of the air vent means. Liquid displaces air from the lower filtering zone during passing through the lower filtering zone. Displaced air is lifted upward by a countercurrent flow and accumulates at the base of the air vent means. When the air sufficient to form a bubble is accumulated in the base of the air vent means, the air rises along the vertical part of the air vent means, then passes the air outlet element and the air holes formed in the lid of the body frame of the liquid purification device and after it leaves the device through the liquid outlet hole.

The liquid purification device according U.S. Pat. No. 6,638,426 has a significant disadvantage. As was noted above, when liquid passes through the lower filtering zone, air flow rises towards liquid flow. Thus, liquid and air flows collides in the lower filtering zone, which prevents the air removal from the filtering zone. Also in the device listed above, an element that directs all air to the vertical part of the air vent means is not provided. Therefore, some air can enter the upper filtering zone through the holes in the base of the air vent means and stay in the upper filtering zone, blocking part of the filtering zone. This effect reduces rate of liquid purification and efficiency of usage and operation of the upper filtering zone. This is a common disadvantage of the liquid purification devices according to U.S. Pat. No. 6,638,426 and Patent Application EP 2754642. These disadvantages also explain the lack of evidence of widespread practical application of U.S. Pat. No. 6,638,426 device.

The liquid purification device according to the Patent RU 2163829 [CJSC “METTEM-TECHNOLOGY”, IPC B01D24/18, B01D27/02, B01D29/56, published on Mar. 10, 2001] is known from the state of the art and is selected by the Applicant as the closest analogue.

The liquid purification device according to the Patent RU 2163829 (the second embodiment) consists of a body frame including an upper and a lower filtering zones with a filter medium arranged therein, a means for changing the direction of feed liquid flow, an air vent means for venting air from the lower filtration zone. The air vent means is made in the form of a vertical tube equipped with an air outlet element located in the upper wall of the air vent means. The liquid purification device is located in the body of a source liquid tank. Wherein the lower filtering zone is located in the lower part of the body of the source liquid tank. A vertical partitions impermeable for liquid are located in the lower filtering zone. The outer vertical partition is located closer to the inner wall of the lower part of the source liquid tank, and the inner vertical partition. The outer section and the inner section are located between these partitions. Two types of the filter material are placed in the outer section. The third type of filter material is placed in the inner section. The sections are limited by partitions permeable for liquid from above and from below. The channel for feed liquid passage is formed between the inner wall of the lower part of the source liquid tank body and the outer impermeable partition. The channel for feed liquid passage is connected to the tube for feed liquid collecting which is located in the central part of the upper filtering zone. At the same time the channel for feed liquid passage is not part of the lower filtering zone, because it ensures only passage of liquid, and not its purification. Said partitions and the channel for feed liquid passage together form the means for changing the direction of feed liquid flow.

The air vent means is inserted into the tube for feed liquid collecting. Stopper permeable for air is located at the top of the air vent means and is made from activated carbon.

The liquid purification device according to the Patent RU 2163829 (the second embodiment) operates as follows. The liquid purification device is installed between the source liquid tank and the purified liquid tank. The source liquid tank is filled with source liquid. In this case, height of a source liquid column should not exceed the height of a vertical part of the air vent means of the liquid purification device. Entering the body frame of the liquid purification device source liquid flows by gravity to the upper filtering zone and through the tube for feed liquid collecting enters down from the top to the channel of the means for changing the direction of feed liquid flow, and then passes to the lower filtering zone. Then liquid enters the lower part of the side section through the partition permeable for liquid, then rises and consistently passes two filter materials of the side section, and through the partition permeable for liquid located on top of the central section inflows into the central section from above. Further purified liquid exits outwards through the hole formed in the lower part of the body frame of the liquid purification device. Air is displaced from volume of the filter material when feed liquid enters the filter material of the side section and passes into the central section. Liquid flow coincides with the direction of air flow since in the side section feed liquid rises from up the bottom. When liquid passes into the central zone, the flow of the incoming feed liquid is countercurrent to air flow that leaves the volume of the filter material.

As indicated in the specification of the patent RU 2163829, since liquid flows through the largest volume of the filter material up from the bottom, so the air vent means for air evolved during filtration is provided. In this case, liquid enters the filter material layer down from the top, colliding with the air bubbles that are present in the filter material layer, makes it difficult for air to flow upwards towards the air vent means and for liquid to flow into the filter material layer, and consequently reduces the rate and degree of liquid purification due to decrease of useful surface area of the filter material. There are the main disadvantages of the said liquid purification device.

### SUMMARY OF THE INVENTION

The object of the invention and the technical effect attained by the invention is to develop the new liquid purification device, to increase the filtration rate while increasing the degree of liquid purification.

The object and the required technical effect are attained in the liquid purification device, consisting of the body frame that includes the upper and the lower filtering zones with the filter medium inside, the means for changing the direction of feed liquid flow, the air vent means for air removal from the lower filtering zone and having the air outlet element located in the upper wall of the air vent means. The device is configured for air removal from the lower filtering zone by an upward feed liquid flow at the beginning of the filtration process during the filling of the device with feed liquid. The means for changing the direction of feed liquid flow containing the filter medium that is simultaneously the lower filtering zone, is formed by the chamber of variable shape and size with the filter medium and with inlet holes located in the upper or the upper and the lower parts of the side wall of this chamber and the vertically oriented inner annular space that is in liquid communication with the chamber through the inlet holes. The space is formed by the inner side wall of the body frame of the liquid purification device and the outer side wall of the chamber and tapers to the lower part of the body frame of the liquid purification device, that contains the filter material, and is designed to pass feed liquid from the upper filtering zone into the chamber through the inlet holes in the radial direction. The air vent means is made of the base and the vertical part, and the base of the air vent means is connected to the upper part of the chamber of the means for changing the direction of feed liquid flow. The base of the air vent means has a resistant to water and to air side walls. The upper limit of the vertically oriented inner annular space extends at the level of the top of the side wall of the base of the air vent means. The lower portion of the chamber of the means for changing the direction of feed liquid flow has at least one sealing element, wherein at least one sealing element is integrally formed with the side wall of the chamber, or at least one sealing element is formed as a separate element connected to the side wall of the chamber. The upper edge of the vertically oriented inner annular space coincides with the boundary layer of the filter material of the upper filtering zone, and at the bottom it coincides with the bottom wall of the body frame of the liquid purification device, where the base of the air vent means is welded to the upper part of the chamber of the means for changing the direction of feed liquid flow. The base of air vent means is integrally formed with the upper part of the chamber of the means for changing the direction of feed liquid flow. The air vent element of the air vent means is formed as an outlet hole for forced-feed air vent having a diameter that obstructs liquid flow down from the top through said outlet hole, therein the hole diameter is less than 1.2 mm, and preferably the hole diameter should be in the range of 0.4 to 1.0 mm. The air vent element of the air vent means is made in the form of a valve opening upward under the pressure of an air bubble and closing down under the pressure of liquid. The air vent element can be made in the form of a membrane valve or in the form of a petal valve or in the form of a capillary having a diameter sufficient to air passage and obstructing liquid flow down, preferably less than 1.2 mm. The filter medium may include sorption materials, such as an activated carbon, an activated carbon fiber, an ion exchange resins, an ion exchange fibers, a hollow fiber elements, a mesh filter materials, a mineralizing materials and a combinations of these materials and elements.

### BRIEF DESCRIPTION OF THE DRAWINGS

Essence of the invention is explained in greater details in the drawings in which

FIG. 1 depicts the liquid purification device.

FIG. 2 depicts the upper filtering zone with the vertical part of the air vent means and the air vent element made in the form of a hole with the diameter of 1 mm, for example.

FIG. 3 depicts the upper filtering zone with the vertical part of the air vent means and the air vent element made in the form of a valve.

FIG. 4 depicts the upper filtering zone with the vertical part of the air vent means and the air vent element made in the form of a capillary.

### DETAILED DESCRIPTION OF THE INVENTION

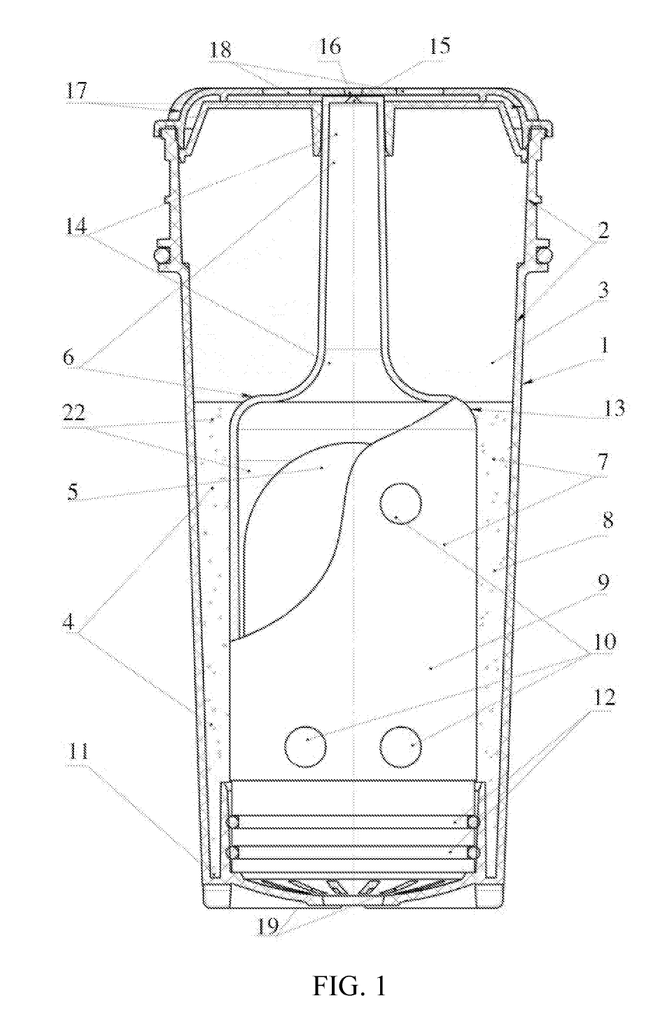

In the claimed invention the liquid purification device (FIG. 1) consists of the body frame 1 comprising of the main part (not presented in figures) and the lid 17 in which the means for source liquid inlet 18 are made in the form of the holes. The upper filtering zone 2 comprising the filter medium 3 made from, for example, and not limited to an activated carbon, an activated carbon fiber, an ion exchange resin, an ion exchange fiber or a mixture of these sorbents, and the lower filtering zone 4 including the hollow fiber element 5 and the sorption filter material 22, the air vent means 6 and the means for changing the direction of feed liquid flow 7 are located in the body frame 1. The outlet holes for purified liquid 19 are provided in the bottom wall of the main part of the body frame 1 of the liquid purification device.

The means for changing the direction of feed liquid flow 7, comprising the filter medium 3 which is the sorption filter material 22 is simultaneously the lower filtering zone 4, and is formed by the chamber with variable shape and size 9 with the inlet holes 10 located in the upper or the upper and the lower parts of side wall of this chamber 9 and the vertically oriented inner annular space 8 that is in liquid communication with the chamber 9 through the inlet holes 10 and is formed by the inner side wall of the body frame 1 of the liquid purification device and the outer side wall of the chamber 9. The upper edge of the vertically oriented inner annular space 8 coincides with the boundary layer of the filter material 22 of the upper filtering zone 2, and at the bottom it coincides with the bottom wall 11 of the body frame 1 of the liquid purification device.

Opposed to the channel for passage of feed liquid in the liquid purification device of the closest analogue, the vertically oriented inner annular space 8 of the claimed invention enters the lower filtering zone 4 and is used not only for feed liquid passage from the upper filtering zone 2 into the chamber 9 through the inlet holes 10 in the radial direction, but also for liquid purification, since it contains the sorption filter material 22.

The lower part of the chamber 9 of the means for changing the direction of feed liquid flow 7 has at least one sealing element 12 which can be made, for example, integrally with the side wall of the chamber 9, or can be made as a separate element connected to the side wall of the chamber 9.

The lower filtering zone 4 is located inside the chamber 9.

The inlet holes 10 for feed liquid formed in the upper part of the chamber 9 are located below the upper edge of the hollow fibers of the hollow fiber element 5, the inlet holes 10 formed in the lower part of the chamber 9 are located closer to the sealing element 12. The sorption filter material 22 is made from, for example, an ion exchange fiber or a mixture of an ion exchange fiber and an activated carbon, and is located to the level of the upper edge of the hollow fibers of the hollow fiber element 5 inside the chamber 9.

The air vent means 6 consists of the base 13 and the vertical part 14, the side walls of which are resistant to liquid and to air. The air vent means 6, for example, can be welded or fitted in the upper part of the chamber 9 of the means for changing the direction of feed liquid flow 7 or can be integrated with the upper part of the chamber 9 of the means for changing the direction of feed liquid flow 7.

The air outlet element of the air vent means 6, for example, can be made in the form of the outlet hole 15 (FIG. 1, 2) for forced-feed air vent having a diameter that obstructs the liquid flow down from the top through the said outlet hole 15. The diameter of the outlet hole 15 should be less than 1.2 mm and preferably should be in the range from 0.4 to 1.0 mm.

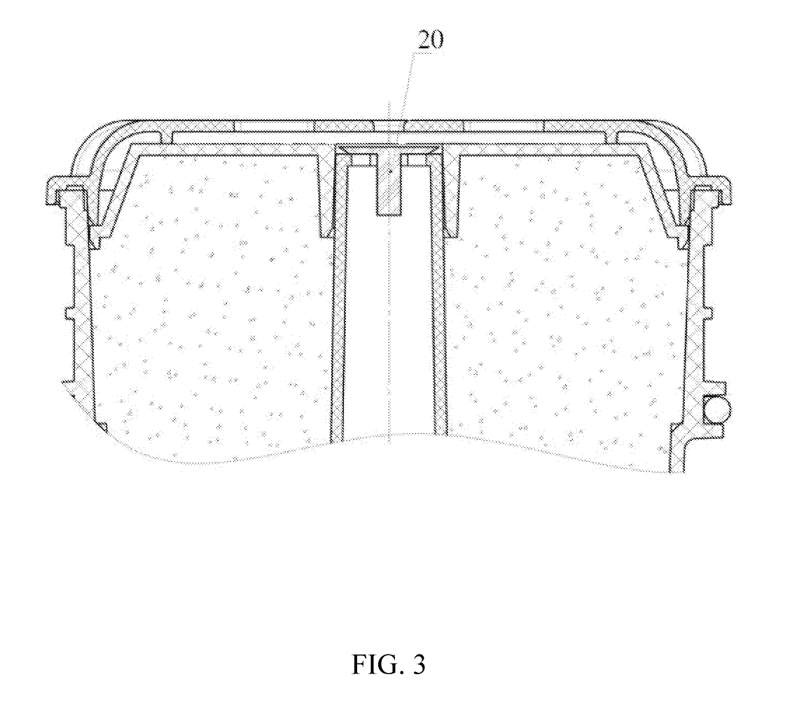

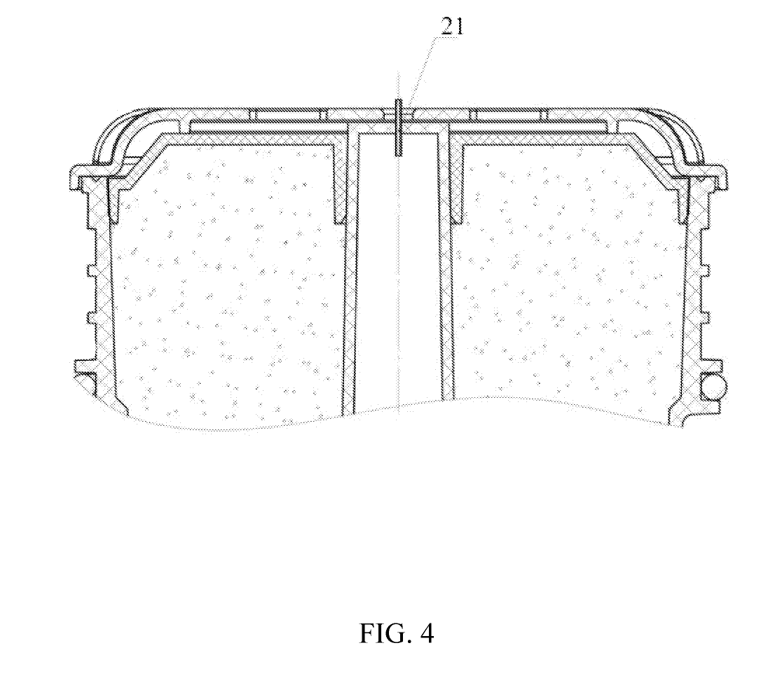

The air vent element of the air vent means 6, for example, can be made in the form of a valve 20 (FIG. 3) opening upward under the pressure of an air bubble and closing down under the pressure of liquid, also in the form of the membrane valve or in the form of the petal valve. Also the air vent element of the air vent means 6 can be made in the form of the capillary 21 (FIG. 4) having a diameter sufficient to air passage and obstructing liquid flow down.

The inlet holes 18 for source liquid are provided in the lid 17 of the liquid purification device. The hole 16 is formed in the central part of the lid 17 and connected to the air vent element.

Additionally the inlet holes 18 for source liquid can be made in the upper portion of the side walls of the main part of the body frame 1 of the liquid purification device.

The outlet holes for purified liquid 19 are provided in the bottom wall of the main body part 1 of the liquid purification device.

Within the features of the invention the liquid purification device described above functions as follows. The liquid purification device is located between the source liquid tank and the purified liquid tank. The source liquid tank (not presented in figures) is filled with source liquid, and opposed to the closest analogue solution, the height of source liquid column can be any. Source liquid flows into the upper filtering zone 2 through the inlet holes 18 in the lid 17, then flows from up to down through the filter material 22 and passes into the vertically oriented inner annular space 8 of the lower filtering zone 4. After passing from up to down at least a part of the vertically oriented inner annular space 8, liquid flows radially through the inlet holes 10 into the chamber 9 of the means for changing the direction of feed liquid flow 7. Inside the chamber 9 liquid flows partially upward and simultaneously radially flows into the hollow fibers by means of capillary forces. In this case, purified liquid exits the liquid purification device through the outlet holes for purified liquid 19.

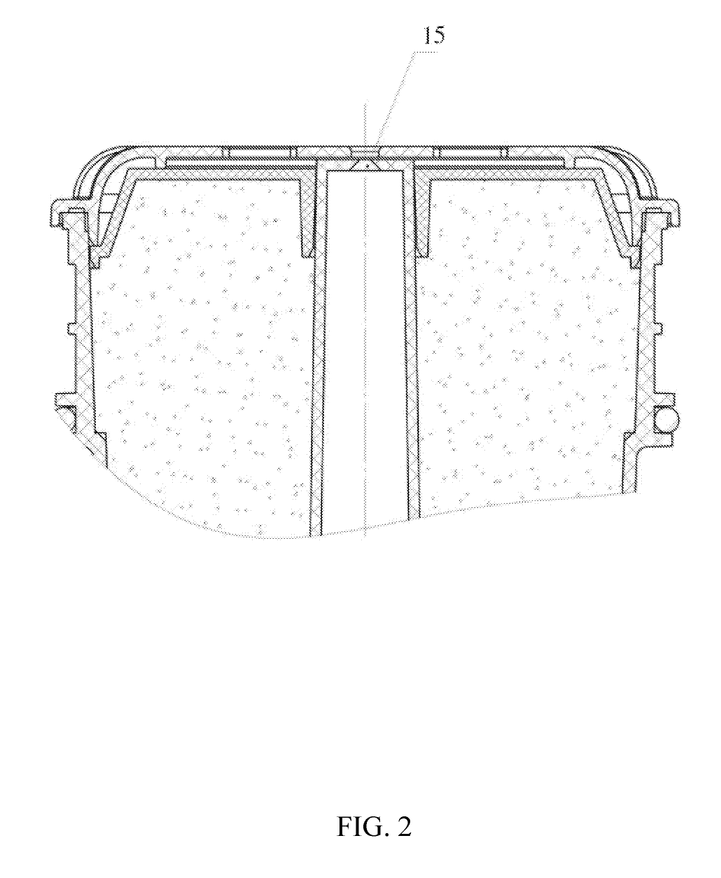

At the same time, air contained in the hollow fiber element 5 moves upward and accumulates in the base 13 of the air vent means 6 due to that part of feed liquid flows upward. An air bubble is formed inside the base 13 of the air vent means 6, which gradually passes into an elastic form. The air vent means 6 is performed in such a way that provides a gradual upward draft of the air bubble within the vertical part 14 of the air vent means 6 and through the air vent element (FIGS. 1 and 2), 20 (FIG. 3), 21 (FIG. 4)) into the external environment. As previously indicated, the sorption filter material 22 in addition to the hollow fiber element 5 is arranged inside the chamber 9, which facilitates a better lifting upward of feed liquid entering the chamber 9 through the inlet holes 10 by capillary forces. Thus, the movement of liquid along the lower filtering zone 4 is directed so that liquid flow provides the upward motion of air flow, and liquid pressure and static voltage force an air bubble upward from the liquid purification device. In this case, since liquid inside the chamber 9 flows both radially and upward, the entire lower filtering zone 4 is involved in the filtration process, that further improves liquid purification efficiency. In this case since liquid moves first downward then radially and upward in the lower filtering zone 4, and all liquid movement is accompanied by a filtration process, then an increase in the degree of liquid purification is achieved.

Thus, at the initial moment of the filtration process, almost the entire volume of air is vented from the lower filtering zone 4 without contact with liquid, which increases the speed of the filtration process and increases the degree of liquid purification.

1. The liquid purification device consisting of the body frame that includes the upper and the lower filtering zones with the filter medium inside, the means for changing the direction of feed liquid flow, the air vent means for air from the lower filtering zone removal and having the air outlet element located in the upper wall of the air vent means, characterized in that the device is configured for air removal from the lower filtering zone by an upward feed liquid flow of at the beginning of the filtration process during the filling of the device with feed liquid and the means for changing the direction of feed liquid flow containing the filter medium that is simultaneously the lower filtering zone and located inside the device, is formed by the chamber of variable shape and size with the filter medium and with the inlet holes located in the upper or the upper and the lower parts of the side wall of this chamber and the vertically oriented inner annular space that is in liquid communication with the chamber through the inlet holes located in the upper or the upper and the lower parts of the side wall of this chamber and formed by the inner side wall of the body frame of the liquid purification device and the outer side wall of the chamber and tapers to the lower part of the body frame of the I iquid purification device, that contains the filter material, and is designed to pass feed liquid from the upper filtering zone into the chamber through the inlet holes in the radial direction.

2. The liquid purification device according to claim 1 characterized in that the air vent means is made of the base and the vertical part, and the base of the air vent means is connected to the upper part of the chamber of the means for changing the direction of feed liquid flow.

3. The liquid purification device according to claim 2 characterized in that the base of the air vent means has side walls resistant to liquid and air.

4. The liquid purification device according to claim 1 or 2 characterized in that the upper edge of the vertically oriented inner annular space extends at the level of the top of the side wall of the base of the air vent means.

5. The liquid purification device according to claim 1 characterized in that the lower part of the chamber of the means for changing the direction of feed liquid flow has at least one sealing element.

6. The liquid purification device according to claim 5 characterized in that at least one sealing element is integrally formed with the side wall of the chamber.

7. The liquid purification device according to claim 5 characterized in that at least one sealing element is formed as a separate element connected to the side wall of the chamber.

8. The liquid purification device according to claim 1 or 5 characterized in that the upper edge of the vertically oriented inner annular space coincides with the boundary layer of the filter material of the upper filtering zone, and from the bottom it coincides with the bottom wall of the body frame of the liquid purification device.

9. The liquid purification device according to claim 2 characterized in that the base of the air vent means is integrally formed with the upper part of the chamber of the means for changing the direction of feed liquid flow.

10. The liquid purification device according to claim 1 characterized in that the air vent element of the air vent means is formed as the outlet hole for forced-feed air vent having a diameter that obstructs liquid flow down from the top through said outlet hole.

11. The liquid purification device according to claim 10 characterized in that the outlet hole diameter is less than 1.2 mm and preferably the outlet hole diameter should be in the range of 0.4 to 1.0 mm.

12. The liquid purification device according to claim 1 characterized in that the air vent element of the air vent means is made in the form of a valve opening upward under the pressure of an air bubble and closing down under the pressure of liquid.

13. The liquid purification device according to claim 12 characterized in that the air vent element can be made in the form of a membrane valve.

14. The liquid purification device according to claim 12 characterized in that the air vent element can be made in the form a petal valve.

15. The liquid purification device according to claim 1 characterized in that the air vent element can be made in the form of a capillary having a diameter sufficient to air passage and obstructing liquid flow down, preferably less than 1.2 mm.

16. The liquid purification device according to claim 1 characterized in that the filter medium may include sorption materials, such as an activated carbon, an activated carbon fiber, an ion exchange resins, an ion exchange fibers, a hollow fiber elements, a mesh filter materials, a mineralizing materials and a combinations of these materials and elements.
